(19) United States
(12) Patent Application Publication
(10) Pub. No.: US 2009/0030120 A1
(43) Pub. Date: Jan. 29, 2009

(54) Electrical Conductive Polymer Composition

(76) Inventors: Josephina Cornelia Maria Zijp, Liempde (NL); Zhe D.J. Chen, Eindhoven (NL)

Correspondence Address: NIXON & VANDERHYE, PC, 901 NORTH GLEBE ROAD, 11TH FLOOR, ARLINGTON, VA, 22203, US

(21) Appl. No.: 11/883,560

(22) PCT Filed: Feb. 9, 2006
(86) PCT No.: PCT/NL2006/000066

§ 371 Date: Feb. 8, 2008

(30) Foreign Application Priority Data
Feb. 9, 2005 (NL) PCT/NL2005/000107

(51) Int. Cl. C08K 5/3417

(52) U.S. Cl. 524/88

(57) ABSTRACT

The present invention relates to a process for the preparation of an electrically conductive polymer composition comprising a thermoset polymer and up to 20 wt. % of electrically conductive particles of an iron or cobalt based phtalocyanine complex, by mixing the complex with one or more of the precursors of the thermoset polymer, after which the resulting mixture is polymerized and in which the particles are administrated in the form of a dispersion in a specific dispersion agent.

The present invention relates to a process for the preparation of an electrically conductive polymer composition comprising a thermoset polymer and up to 20 wt. % of electrically conductive particles of an iron or cobalt based phthalocyanine complex, by mixing the conductive particles with one or more of the precursors of the thermoset polymer, after which the resulting mixture is crosslinked. It also relates to the resulting polymer composition, as well as to a coated product, comprising a substrate and the polymer composition.

Such a process, the resulting composition and its use are known from WO-A-93/24562.

In recent years, blending of an insulating polymer with conducting fillers has attracted considerable interest due to the potential applications of the resulting composites in many areas where a certain level of conductivity is required. The conductive fillers applied range from metallic powders to carbonaceous fillers including carbon black, graphite and carbon fibers. Intrinsically conductive polymers (ICPs), such as polyaniline or polypyrole, are sometimes also used. A broad range of standard polymers are used as the matrix, and the increase in conductivity is caused by the formation of a particle network through the polymer matrix. The main problem involved in this field is the large amount of conductive fillers required to achieve reasonable conductivity levels for practical applications. This large amount of filler deteriorates the mechanical properties of the composite, and leads to poor processabiltiy of the matrix. Furthermore, the cost of the final material is often beyond the acceptable range, due to the heavy fraction of expensive conducting species.

Generally, the relationship between the dc (direct current) volume conductivity (σᵥ) of a polymer composite and filler loading is not linear. The σᵥ increases sharply at a critical conductive filler concentration known as the percolation threshold (φ_{c}). Several theories have been developed to understand such a drastic transition. Statistical percolation models have occupied the majority of the literature. These models predict a percolation threshold at a volume fraction of 0.16 in 3 dimensions for round particles.

It is a first objective of this invention to provide a process as a result of which the percolation threshold of the polymer composition is significantly lowered.

It has been found that, when practicing the teachings of the above-mentioned prior art, only conductivity of the bulk of the polymer matrix was obtained. In fact an isolating top layer having of a thickness of several microns was found.

Therefore another objective of the present invention is to provide a process resulting in the preparation of a substrate coated with a thermoset polymer wherein the coating shows substantially no difference in bulk and top layer conductivity.

Still another objective of the underlying invention is to provide a process to obtain a coating of which the conductivity level, at a given concentration of the conductive particles, can be tuned to desired levels.

The indicated objectives are achieved by a process, in which the particles of the conductive complex are administered to the one or more precursors of the thermoset polymer in the form of a dispersion in a dispersion agent, the chemical structure of the dispersion agent being such that it comprises at least one of the following groups:

### —OH

### —C═O

### —S═O

### —Ph—R

### —NR₂,

in which each R is hydrogen or a (substituted) hydrocarbon group.

In the following, details of the ingredients and the process will be given.

a) Thermoset Polymer.

The aim of the invention is to prepare an electrically conductive polymer composition based on a thermoset polymer. Thermoset polymers as such and their preparation are known in the art. They are prepared by crosslinking a monomer or a mixture of monomers, conventionally with the aid of one or more crosslinker agents; such ingredients here and thereinafter also being referred to as precursor (s) of the thermoset polymer.

Preferably the thermoset polymer is selected from the group of thermoset epoxy resins, thermoset polyurethanes, thermoset formaldehyde resins, thermoset acrylic urethane systems, thermoset polyesters, and/or thermoset poly(alkyl-) acrylates. In case of the thermoset poly(alkyl-) acrylates, preference is given to thermoset polymethylacrylates or polymethylmethacrylates.

The conditions under which the crosslinking of the precursor(s) takes place are known to the skilled man. Said crosslinking eventually results in a thermoset polymer, which means that such a polymer is not melt-processable; this in contrast to thermoplastic polymers.

b) Electrically Conductive Particle.

This particle is an iron or cobalt based phthalocyanine complex. Such a complex is known from WO 93/24562, the contents of which are herein incorporated by reference. Also EP-A-261,733 discloses these type of compounds. The primary particle sizes are generally well below 1 μm. At larger sizes, the formation of a network is between the particles in the composition troublesome.

c) Dispersion Agent.

The dispersion agent in and with which a dispersion of the electrically conductive particles is made, comprises at least one of the following groups:
—OH
—C═O
—S═O
—Ph—R
—NR₂,
   in which Ph stands for a (substituted) phenylgroup, and each R is hydrogen or a (substituted) hydrocarbon group. More preferred, the dispersion agent comprises two or more of the indicated groups, either identical or different from each other. An non-exhaustive list of applicable dispersion agents comprises the following chemicals: cyclohexanone, sulfolane, dimethylacetamide, ethylene glycol, glycerol, glycol monostearate, polyethylene glycol, DMPU, DMIL (2,3-dimethyl-2-imidazo-lidanone, n-methylpyrrolidone, HMPTA (hexamethylphodphor triamide), Linevol (butylbenzylphthalate), concentrated H₂SO₄, trifluormethanesulphonic acid, m-cresol, ethylene carbonate.

A preference is present for the use of a dispersion agent selected from the group comprising alkylene glycols, or alkyl- or aryl phenols. More preferred, the dispersion agent is either ethylene glycol or m-cresol.

d) The Dispersion.

In the present invention it is an essential element that the electrically conductive particles are premixed in a dispersion agent (both ingredients as described above). This mixing and dispersing is a process in which known techniques for preparing a dispersion can be used. Dependant on the properties of the respective ingredients, and the conditions of the polymerization, a skilled man is able to determine the process conditions under which the dispersion is prepared. The temperature at which the dispersion is made can either be room temperature or an elevated temperature.

The concentration of the electrically conductive particles in the dispersion is not critical. In order to be easy processable, the dispersion comprises preferably up to 50 wt % of the phthalocyanine complex particles. It is preferable to start with a dispersion in which the particles are finely dispersed.

e) The Crosslinker.

In order to prepare a thermoset polymer, generally there is a need, next to the monomeric precursor(s) of the polymer, to use a crosslinker. As such, the skilled man is acquainted with applicable and suitable crosslinkers to be used for the preparation of the specific thermoset polymer. In the case of a thermoset epoxy resin, this polymer is preferably prepared from a precursor containing at least two epoxy groups, and a diamine-based crosslinker. In that case the crosslinker has the formula:

H₂N—Rₓ—(O—R_{y})ₙ—NH₂,

in which Rₓ and R_{y} are a hydrocarbon group,
and in which n has a value between 1 and 75.

Preferably, the hydrocarbon groups Rₓ and R_{y} are both an isopropylene group.

It has surprisingly been found that by matching the length of the backbone of the crosslinker agent (i.e. by varying the value of n in the above formula, and thus the molecular weight), that a glassy or a rubbery nature of the coating can be achieved (the higher value of n, the more rubbery the coating becomes). In preference, n has a value between 3 and 60. The variation in the value of n, and thus of the molecular weight of the crosslinker, surprisingly also gives an opportunity to control the conductively level of the resulting conductive polymer composition: the higher the molecular weight, the lower the conductivity level (in S/cm), at a given concentration of the electrically conductive species in the polymer composition.

f) The Electrically Conductive Polymer Composition.

Through the present invention an improved conductive polymer composition is obtained, having a significantly lowered percolation threshold, compared to polymer compositions known in the art. An additional, and significant effect of the present invention is the fact that there is substantially no difference in bulk and top layer conductivity; this in contrast with polymer compositions prepared according to a process known in the art. As a result, as electrically conductive polymer composition is achieved, comprising preferably up to 20 wt % of an electrically conductive iron or cobalt based phthalocyanine complex, and wherein there is substantially no difference in bulk and top layer conductivity.

g) The Process.

The process for preparing the polymer of the coating composition is as such known from the art. Reference can be given to the afore mentioned WO-A-93/24562. It has been found that, depending on the type of matrix, an optimal processing window is present, outside which only a partially or even a non-conductive product is obtained. When the polymerization temperature is too low, the dispersed particles have a tendency to sediment before the polymerization has fully taken place. When the temperature is too high, the curing process is faster than the mixing process of the dispersion with the precursors of the thermoset polymer.

With the above in mind, the skilled man will be aware of the suitable processing window for each thermoset polymer to be used in the present invention. For example, for an epoxy based polymer this processing window is between 40 and 140° C.

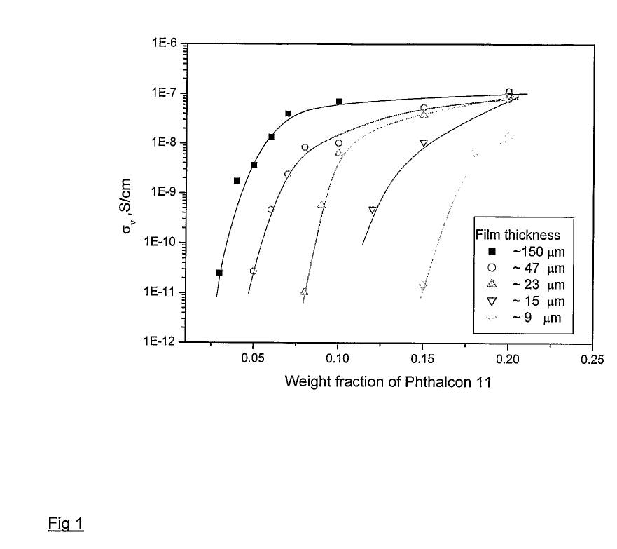

It was found that the volume conductivity σᵥ was dependent on the thickness of the coating. The thinner the coating, the lower the σᵥ, and the higher the percolation threshold (φ). The results are given in FIG. 1.

It has been found that the lowest percolation threshold value for the results given in FIG. 1 is 0.9 wt %, for a thickness of the film ≧200 μm. This allows to also adept the desired level of conductivity with the film thickness.

In general, the polymer composition of the present invention can be used as a coating on a substrate. Said substrate can comprise either an organic or inorganic substrate. An organic substrate generally has a polymeric nature. Examples of a suitable substrate are: polyamide, polycarbonate, glass, metal.

### EXAMPLE I

0.056 g Phthalcon 11 (electrically conductive complex with a particle size of about 500*250*50 nm) was dispersed at room temperature in 0.497 g m-cresol for 1 h. The dispersion was put in an ultrasonic bath and dispersed further for 1 h at room temperature.

The invention will be elucidated with the following Examples and comparative experiments, which are meant to illustrate the invention but not to restrict it.

The resulting dispersion was mixed with 0.369 g Epikote 828 (polymer precursor) and 0.131 g Jeffamine D-230 (crosslinker) with a magnetic stirrer for 2 min at room temperature. Then the mixture was degassed in an ultrasonic bath (under degassing mode) for 5 minutes at room temperature. This degassed mixture was then applied on polycarbonate panels (GE Plastics, The Netherlands) with a doctor blade applicator (90 μm wet thickness).

The coated polycarbonate was put in a vacuum oven and cured (crosslinked) at 100° C. for 4 hours, postcured at 120° C. for 20 hours, and then taken out of the oven to cool down to room temperature. The thickness of the dried coating (measured with a micrometer) was 49 μm, which is an average of at least 5 measurements at different places (fault of measurements within 10%).

On the top of the resulting coating four parallel stripes of silver paint (Silver conductive adhesive 416, EMS, USA) were applied, (2 cm in length, 2 mm in width and with 1 cm distance between two neighboring stripes to minimize the contact resistance between coating and electrodes). The conductivity was measured with four pin electrodes in contact with the four silver paint stripes. The outer two electrodes were connected to a power source (Keithley 237) and the inner two were connected to a high voltage electrometer (Keithley 6517A). The former unit supplied a constant current (I, expressed in Ampere) through the coating; the latter unit measured the voltage difference (ΔV, expressed in Volt) between the two inside electrodes. The measurements were carried out according to standard ASTM D991, and according to the instructions of Keithley “Low Level Measurements”.

The volume conductivity (σᵥ) was calculated according to the equation:

$${σ}_{v} = \frac{I * L}{Δ V * b * h}$$

where L (expressed in centimeter) is the distance between two neighboring silver paint stripes, b is the length of the stripe (expressed in centimeter) and h (expressed in centimeter) is the coating thickness.

The actual conductivity measured of the above-mentioned coating was 1.1×10⁻⁷ S/cm, which is the average value of 6 measurements shown below.

TABLE 1

| I, (nA) | ΔV, (mV) | Coating thickness, (μm) | σᵥ, (S/cm) |
|---|---|---|---|
| 1.0 | 0.90 | 49 | 1.1 × 10⁻⁷ |
| 2.5 | 1.80 | 49 | 1.1 × 10⁻⁷ |
| 5.0 | 4.52 | 49 | 1.1 × 10⁻⁷ |
| 10.0 | 8.97 | 49 | 1.1 × 10⁻⁷ |
| 25.0 | 17.65 | 49 | 1.1 × 10⁻⁷ |
| 50.0 | 42.88 | 49 | 1.2 × 10⁻⁷ |

### Comparative Experiments A-C

Example I was repeated, but without the preparation in advance of a dispersion of the Phthalcon 11. The Phthalcon concentration was 5, 10 and 20 wt. % (respectively) and the dispersion was made in Jeffamine 230 as well as in Epikote 828; the molar ratio between Epikote 828 and Jeffamine 230 was 2:1.

All these coatings appeared to be nonconductive (σᵥ<10⁻¹² S/cm), even at a filler concentration as high as 20 wt % when the coatings were measured with the four point set up. By both 2-D optical microscopy and 3-D confocal laser scanning microscopy it was revealed that the particle network was inhomogeneously distributed through the coating in the coatings made from the Phthalcon 11/Jeffamine 230 dispersion, and particle networks were not detected at the surface of the coatings. Because the 4-point conductivity measurements were carried out on the surface of the coating material, the surface morphology of the coating, i.e., the absence of these networks at the surface may be responsible for σᵥ<10⁻¹² S/cm. Therefore a non-contacting electrostatic voltmeter method to measure the bulk conductivity was used. The results showed that the epoxy based coating containing 10 wt % of Phthalcon 11 was already conductive (σᵥ is 4.2×10⁻⁷ S/cm) (comparative experiment B). No conductivity could be measured for the coatings containing a smaller amount of Phthalcon 11 (comparative experiment A). In none of the coatings, made from the Epikote 828 dispersion, conductivity could be measured using both measuring methods mentioned above. No Phthalcon 11 particle network was found using microscopic techniques. These techniques also showed that most of the Phthalcon particles were present in the matrix, both before and after cure, as agglomerates of several microns.

### EXAMPLES II-XVI

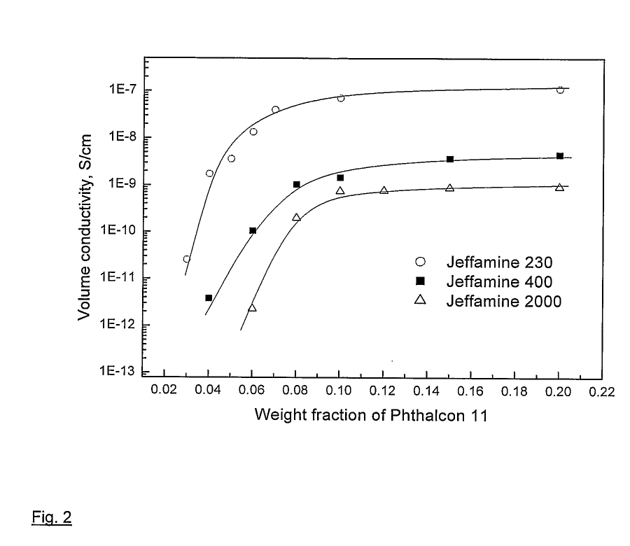

These Examples were performed in a similar way as Example I. The details of the experimental conditions and results are given in Table 2 and FIG. 2.

TABLE 2

| | Phthalcon | | Epikote | Jeffamine | Coating | |
|---|---|---|---|---|---|---|
| | 11 | m-cresol | 828 | species and | thickness | σᵥ, |
| Example | (g) | (g) | (g) | amount (g) | (μm) | (S/cm) |
| II | 0.020 | 0.505 | 0.378 | D-230, | 45 | 2.6 × 10⁻⁹ |
| | | | | 0.131 | | |
| III | 0.026 | 0.505 | 0.365 | D-230, | 51 | 3.6 × 10⁻⁹ |
| | | | | 0.130 | | |
| IV | 0.032 | 0.491 | 0.365 | D-230, | 37 | 1.3 × 10⁻⁸ |
| | | | | 0.131 | | |
| V | 0.037 | 0.490 | 0.372 | D-230, | 50 | 4.0 × 10⁻⁸ |
| | | | | 0.132 | | |
| VI | 0.125 | 0.504 | 0.370 | D-230, | 50 | 7.1 × 10⁻⁸ |
| | | | | 0.131 | | |
| VII | 0.021 | 0.507 | 0.312 | D-400, | 37 | 3.8 × 10⁻¹² |
| | | | | 0.171 | | |
| VIII | 0.032 | 0.505 | 0.315 | D-400, | 42 | 1.1 × 10⁻¹⁰ |
| | | | | 0.171 | | |
| VIX | 0.043 | 0.505 | 0.311 | D-400, | 59 | 1.0 × 10⁻⁹ |
| | | | | 0.170 | | |
| X | 0.056 | 0.500 | 0.315 | D-400, | 47 | 1.5 × 10⁻⁹ |
| | | | | 0.169 | | |
| XI | 0.088 | 0.503 | 0.311 | D-400, | 49 | 3.8 × 10⁻⁹ |
| | | | | 0.171 | | |
| XII | 0.125 | 0.505 | 0.311 | D-400, | 34 | 4.5 × 10⁻⁹ |
| | | | | 0.170 | | |
| XIII | 0.043 | 0.505 | 0.136 | D-2000, | 45 | 2.0 × 10⁻¹⁰ |
| | | | | 0.365 | | |
| XIV | 0.056 | 0.502 | 0.135 | D-2000, | 49 | 7.5 × 10⁻¹⁰ |
| | | | | 0.371 | | |
| XV | 0.088 | 0.505 | 0.132 | D-2000, | 42 | 7.8 × 10⁻¹⁰ |
| | | | | 0.370 | | |
| XVI | 0.125 | 0.505 | 0.130 | D-2000, | 35 | 9.3 × 10⁻¹⁰ |
| | | | | 0.370 | | |

### EXAMPLE XVII

Example I was repeated with the only exception of the wet thickness of the coating used in the doctor blade application: 300 μm instead of 90 μm. The thickness of the resulting cured coating was 137 μm; the volume conductivity measured was 7.2×10⁻⁸ S/cm.

### EXAMPLES XVIII-XXIII

These were performed in a similar way as Example I. The details of the experimental conditions and results are given in Table 3.

TABLE 3

| | Phthalcon | | Epikote | | Coating | |
|---|---|---|---|---|---|---|
| | 11 | m-cresol | 828 | Jeffamine | thickness | σᵥ |
| Example | (g) | (g) | (g) | (g) | (μm) | (S/cm) |
| XVIII | 0.056 | 0.505 | 0.378 | 0.131 | 105 | 9.8 × 10⁻⁸ |
| XIX | 0.056 | 0.503 | 0.375 | 0.130 | 82 | 5.6 × 10⁻⁸ |
| XX | 0.056 | 0.500 | 0.370 | 0.131 | 37 | 6.3 × 10⁻⁸ |
| XXI | 0.056 | 0.499 | 0.372 | 0.135 | 11 | 1.1 × 10⁻¹¹ |
| XXII | 0.056 | 0.505 | 0.375 | 0.131 | 9 | 7.9 × 10⁻¹² |
| XXIII | 0.088 | 0.505 | 0.370 | 0.131 | 5 | 2.1 × 10⁻¹¹ |

### EXAMPLE XXIV

Phthalcon 11 was dried at 80° C. for 48 h under vacuum prior to use.

0.056 g Phthalcon 11 was added to 0.497 g m-cresol at room temperature. 0.014 g Epikote 828 was also added to the mixture. Then the mixture was dispersed for 1 hour magnetically and then ultrasonically dispersed for 1 hour. Both dispersions were performed at room temperature.

To this dispersion 0.361 g Epikote 828 and 0.130 g Jeffamine 230 were added. The mixture was magnetically stirred for 2 minutes and then ultrasonically degassed for 5 minutes at room temperature.

From this mixture a cured coating was made according to the procedure described in Example I. The thickness of the cured coating was 52 μm and the volume conductivity measured was 1.1×10⁻⁶ S/cm.

### EXAMPLES XXV-XXXVI

These Examples were executed in a similar way as described in Example XXIV. The variations between the Examples, and their results are given in Tables 4 and 5.

TABLE 4

| | | | | Amount of | | | |
|---|---|---|---|---|---|---|---|
| | Phthalcon | m- | Epikote | Jeffamine | Overall | Coating | |
| | 11 | cresol | 828 | added during | Jeffamine | thickness | σᵥ |
| Example | (g) | (g) | (g) | dispersion (g) | (g) | (μm) | (S/cm) |
| XXV | 0.056 | 0.505 | 0.370 | 0 | 0.131 | 42 | 3.8 × 10⁻⁷ |
| XXVI | 0.056 | 0.495 | 0.375 | 0.007 | 0.131 | 53 | 6.6 × 10⁻⁸ |
| XXVII | 0.056 | 0.500 | 0.370 | 0.014 | 0.134 | 29 | 4.8 × 10⁻⁸ |
| XXVIII | 0.056 | 0.505 | 0.370 | 0.028 | 0.131 | 52 | 3.8 × 10⁻⁸ |
| XXIX | 0.056 | 0.495 | 0.375 | 0.063 | 0.128 | 51 | 5.0 × 10⁻⁸ |
| XXX | 0.056 | 0.505 | 0.370 | 0.130 | 0.130 | 50 | 5.0 × 10⁻⁸ |

TABLE 5

| | | | Jeffamine | Amount of | Overall | | |
|---|---|---|---|---|---|---|---|
| | Phthalcon | m- | D-230 | Epikote828 | Epikote | Coating | |
| | 11 | cresol | amount | added during | 828 | thickness | σᵥ |
| Examples | (g) | (g) | (g) | dispersion (g) | amount (g) | (μm) | (S/cm) |
| XXXI | 0.056 | 0.500 | 0.131 | 0.014 | 0.375 | 52 | 1.1 × 10⁻⁶ |
| XXXII | 0.056 | 0.505 | 0.127 | 0.038 | 0.370 | 50 | 1.3 × 10⁻⁷ |
| XXXIII | 0.056 | 0.500 | 0.130 | 0.075 | 0.370 | 35 | 4.4 × 10⁻⁸ |
| XXXIV | 0.056 | 0.505 | 0.131 | 0.125 | 0.371 | 64 | 2.8 × 10⁻⁸ |
| XXXV | 0.056 | 0.505 | 0.130 | 0.370 | 0.370 | 51 | 5.0 × 10⁻⁸ |
| XXXVI | 0.056 | 0.505 | 0.370 | 0.130 | 0.130 | 47 | 3.0 × 10⁻⁸ |

### EXAMPLES XXXVI AND XXXVII

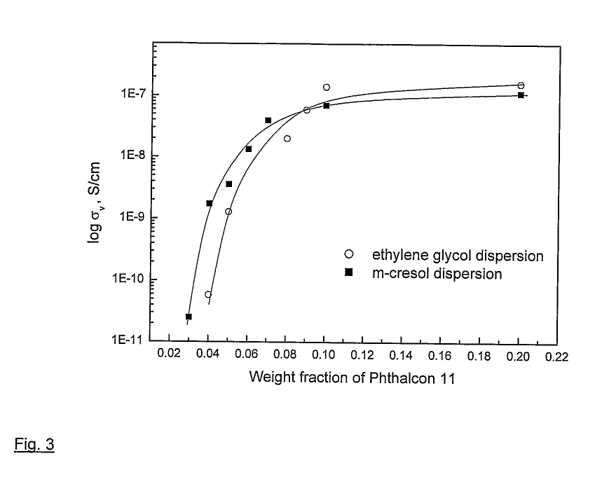

Example I was repeated with different Phthalcon 11 concentrations, using either m-cresol or ethylene glycol as the dispersion agent. The results are given in FIG. 3.

By extrapolating the σᵥ-[Phthalcon 11] curve to 10⁻¹⁷ S/cm (the conductivity of the pure epoxy matrix), the percolation threshold of Phthalcon 11/epoxy was determined. For the ethylene glycol dispersed coating a percolation threshold of 1.5 wt. % was achieved, for the m-cresol dispersed coating a value of 1.2 wt. % was found.

The curves in FIG. 3 were also fitted according to the scaling law of the percolation theory (according to Rolduglin et. al. (Progress in organic coatings, 2000, 39, 81, 100)):

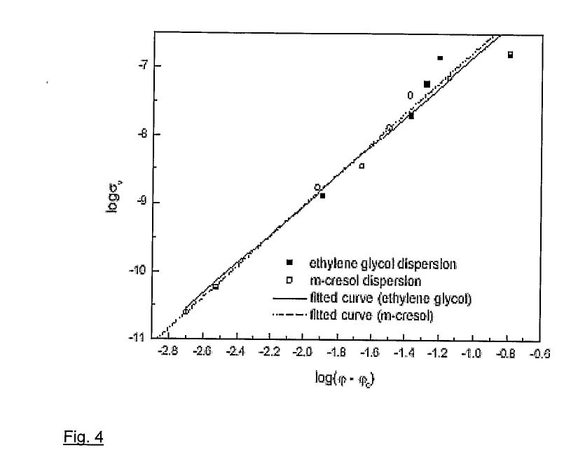

σᵥ˜c(φ−φ_{c})^{t}

where c is a constant, t is the critical exponent, and φ is the volume fraction of the filler particles and φ_{c} is the percolation threshold. The value of t is 2.03 for the ethylene glycol dispersed coating and 2.15 for the m-cresol dispersed coating (FIG. 4).

The percolation threshold (φ_{c}≈1.4 wt. %) found for both cured Phthalcon 11/epoxy coatings is much lower than the values in the art.

### EXAMPLE XXXVIII

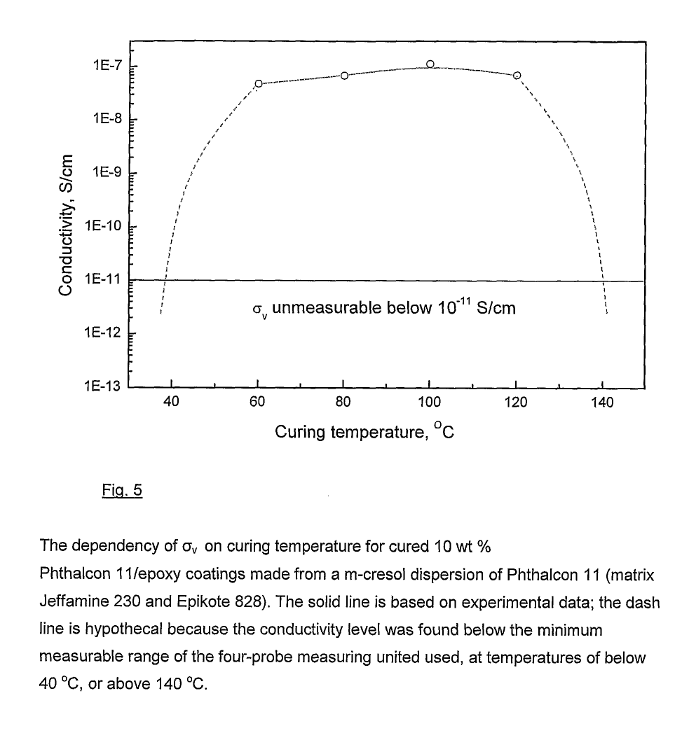

In this Example the influence of the reaction temperature on the conductivity was determined; all according to the further conditions of Example I. The results are given in FIG. 5.

1. Process for the preparation of an electrically conductive polymer composition comprising a thermoset polymer and up to 20 wt. % of electrically conductive particles of an iron or cobalt based phthalocyanine complex, by mixing the conductive particles with one or more of the precursors of the thermosetting polymer after which the resulting mixture is crosslinked,
wherein the particles of the complex are administered to the one or more precursors of the thermoset polymer in the form of a dispersion in a dispersion agent, the chemical structure of the dispersion agent being such that it comprises at least one of the following groups:
—OH
—C═O
—S═O
—Ph—R
—NR₂,
in which each R is hydrogen or a (substituted) hydrocarbon group.

2. Process according to claim 1, wherein the thermoset polymer is selected from the group comprising thermoset epoxy resins, thermoset polyurethanes, thermoset formaldehyde resins, thermoset acrylic-urethane resins, thermoset polyesters, and/or thermoset poly(alkyl-) acrylates.

3. Process according to claim 1, wherein the dispersion agent comprises two or more of the indicated groups.

4. Process according to claim 1, wherein the dispersion agent is selected from the group comprising alkylene glycols, or alkyl- or aryl phenols.

5. Process according to claim 4, wherein the dispersion agent is ethylene glycol or m-cresol.

6. Process according to claim 1, wherein the dispersion comprises up to 50 wt. % of the phthalocyanine complex.

7. Process according to claim 2, wherein the thermoset epoxy resin is prepared from a precursor containing at least two epoxy groups, and a di-amine based crosslinker.

8. Process according to claim 7, wherein the crosslinker has the formula:
H₂N—Rₓ—(O—R_{y})ₙ—NH₂,
in which Rₓ and R_{y} are a hydrocarbon group,
and in which n has a value between 1 and 75.

9. Process according to claim 8, wherein Rₓ and R_{y} are both an isopropylene group.

10. Process according to claim 8, wherein n has a value between 3 and 60.

11. Process according to claim 1, wherein the phthalocyanine complex is present in the polymer composition in at most 10 wt. %; preferably in at most 5 wt. %.

12. Electrically conductive polymer composition comprising a thermoset polymer and up to 20 wt. % of an electrically conductive iron or cobalt based phthalocyanine complex, having substantially no difference in bulk and top conductivity.

13. Electrically conductive polymer composition comprising a thermoset polymer and up to 20 wt. % of an electrically conductive iron or cobalt based phthalocyanine complex, having substantially no difference in bulk and top conductivity, wherein the polymer composition is obtained by a process according to claim 1.

14. Coated product, comprising a substrate and a polymer composition according to claim 12.
